(19) United States
(12) Patent Application Publication
(10) Pub. No.: US 2022/0398471 A1
(43) Pub. Date: Dec. 15, 2022

(54) NEURAL NETWORK EXPLANATION USING LOGIC

(71) Applicant: SRI International, Menlo Park, CA (US)

(72) Inventor: Andrew Silberfarb, San Diego, CA (US)

(21) Appl. No.: 17/776,152

(22) PCT Filed: Mar. 17, 2021
(86) PCT No.: PCT/US21/22747

§ 371 Date: May 11, 2022

Related U.S. Application Data
(60) Provisional application No. 63/030,699, filed on May 27, 2020.

(51) Int. Cl. G06N 5/04; G06N 20/00

(52) U.S. Cl. CPC G06N 5/045; G06N 20/00

(57) ABSTRACT

The explanation engine has a set of modules cooperating with each other configured to evaluate layers in a hierarchical architecture of a machine-based reasoning process that uses machine learning. The set of modules cooperate to support an explanation of how the machine-based reasoning process arrived at its reported results of both a final/top level result as well as corresponding intermediate output results. A messaging module of the explanation engine can collect the top-level result as well as one or more intermediate output results from intermediate layers of the machine-based reasoning process. Multiple layers of reasoning are associated with terminology used in at least one of i) a problem to be solved and ii) a domain pertinent to the problem in order to communicate how the machine-based reasoning process came to its reported results in a communication.

### CROSS-REFERENCE

This application claims priority under 35 USC 119 to U.S. provisional patent application Ser. 63/030,699, titled “NEURAL NETWORK EXPLANATION USING LOGIC,” filed 27 May 2020, which the disclosure of such is incorporated herein by reference in its entirety.

### TECHNICAL FIELD

Embodiments of this disclosure relate generally to artificial intelligence-based reasoning engines.

### BACKGROUND

Today the problem of understanding the outputted results from computer reasoning is typically addressed through post-hoc explanation, which may not match what the system actually does, leading to a disconnect between the provided explanation and the actual factors causing the system performance.

### SUMMARY

Provided herein are various methods, apparatuses, and systems for an artificial intelligence based reasoning engine and explaining its reasoning process.

The explanation engine has a set of modules cooperating with each other configured to evaluate layers in a hierarchical architecture of a machine-based reasoning process that uses machine learning. The set of modules cooperate to support an explanation of how the machine-based reasoning process arrived at its reported results of both a final/top level result as well as corresponding intermediate output results. A messaging module of the explanation engine can collect the top-level result as well as one or more intermediate output results from intermediate layers of the machine-based reasoning process. Multiple layers of reasoning are associated with terminology used in at least one of i) a problem to be solved and ii) a domain pertinent to the problem in order to communicate how the machine-based reasoning process came to its reported results in a communication.

These and many more embodiments are discussed.

### DRAWINGS

FIG. 1 illustrates a block diagram of an embodiment of an example explanation engine having a set of modules to evaluate layers in a hierarchical architecture of a machine-based reasoning process;

FIG. 2 illustrates an embodiment of an example reasoning engine configured to break down its machine-based reasoning process into divisible layers that provide intermediary output results to other layers and a top level result;

FIG. 3 illustrates an embodiment of a block diagram of example layers in a hierarchical architecture of a machine-based reasoning process created by a reasoning engine with terminology used in at least one of i) a problem being solved and ii) a domain pertinent to the problem;

FIG. 4 illustrates a block diagram of an embodiment of the example machine-based reasoning process and the modules of the explanation engine set to interact with and crawl through a decomposition of the machine-based reasoning process, collect the information, and then report intermediate output results from each layer of the reasoning process to explain the top-level result in terms of the intermediate output results;

FIG. 5 illustrates a block diagram of an embodiment of an example problem specific terminology where the terminology that is assigned to each layer of the machine-based reasoning process can come directly from a user provided written description of the problem and/or is extracted from a domain specific database;

FIG. 6 illustrates a block diagram of an embodiment of an example communication generated by a messaging module cooperating with an ablation module to trace back on each intermediate layer of the machine-based reasoning process to record factors being considered and how important that factor was into arriving at the top-level result from the machine-based reasoning process;

FIG. 7 illustrates a block diagram of an embodiment of another page in the communication generated by the messaging module explaining potential errors or improvements in the machine-based reasoning process;

FIG. 8 illustrates a diagram of a number of electronic systems and devices communicating with each other in a network environment in accordance with an embodiment of the explanation engine cooperating with a reasoning engine; and

FIG. 9 illustrates a diagram of an embodiment of one or more computing devices that can be a part of the systems associated with the explanation engine cooperating with the reasoning engine and its associated models discussed herein.

While the design is subject to various modifications, equivalents, and alternative forms, specific embodiments thereof have been shown by way of example in the drawings and will now be described in detail. It should be understood that the design is not limited to the particular embodiments disclosed, but—on the contrary—the intention is to cover all modifications, equivalents, and alternative forms using the specific embodiments.

### DESCRIPTION

In the following description, numerous specific details can be set forth, such as examples of specific data signals, named components, number of frames, etc., in order to provide a thorough understanding of the present design. It will be apparent, however, to one of ordinary skill in the art that the present design can be practiced without these specific details. In other instances, well known components or methods have not been described in detail but rather in a block diagram in order to avoid unnecessarily obscuring the present design. Further, specific numeric references such as the first server, can be made. However, the specific numeric reference should not be interpreted as a literal sequential order but rather interpreted that the first server is different than a second server. Thus, the specific details set forth can be merely exemplary. The specific details can be varied from and still be contemplated to be within the spirit and scope of the present design. The term “coupled” is defined as meaning connected either directly to the component or indirectly to the component through another component.

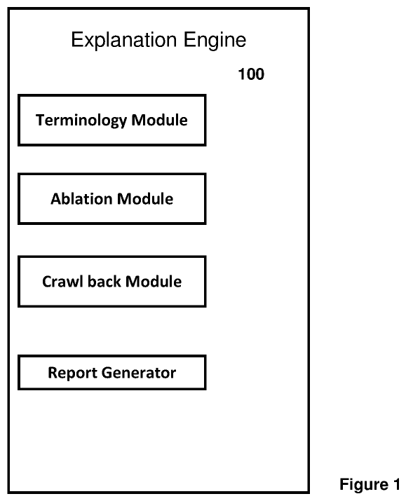

FIG. 1 illustrates a block diagram of an embodiment of an example explanation engine having a set of modules to evaluate layers in a hierarchical architecture of a machine-based reasoning process.

The explanation engine 100 has the set of modules cooperating with each other to evaluate layers of a hierarchical architecture (including a mix of layers implemented in neural networks, logical rules, linear layers, etc. and any combination of these) of a machine-based reasoning process that uses machine learning to support a detailed explanation of how the machine-based reasoning process arrived at its reported results of both a top level result as well as corresponding intermediate output results.

The explanation engine 100 has a terminology module configured to accept input of terminology for the problem to be solved by the reasoning engine and the machine-based reasoning process that is supplied by at least one of i) a to be solved from a user ii) a description of preferred approach to solve the problem from a user, and iii) a database of known terminology specific to the domain pertinent to the problem. Note, terminology can refer to an understanding and appropriate use of and meaning of language constructs, such as terms, symbols, acronyms, etc., used in that subject domain and/or described problem to be solved. The terminology module of the explanation engine 100 also adapts the terminology (e.g., words, symbols, acronyms, etc.) for each layer in the hierarchical architecture of the machine-based reasoning process from the reasoning engine to the domain and specific problem at hand.

Note, the explanation engine 100 uses a single/common explanation method across multiple different domains and different types of problems that allows any of its users to match between the explanations produced by the reasoning engine and its machine-based reasoning process and the explanations they receive from the generated communication such as a report, email, etc. The generated communication contains more information fully explaining how the machine-based reasoning/learning arrived at its outputted result in the language specific to the subject domain or problem at hand.

The modules of the explanation engine 100 try to provide an explanation for what decisions and factors went into the final/top level results from the machine-based reasoning (e.g., computer generated machine learning reasoning) by providing one or more intermediate decisions made to arrive at the generated final/top level results. The intermediate decisions on how machine learning reasoning arrived at its generated results are included in a communication from the explanation engine 100 to support a user's understanding of why a particular final/top level result was provided by an automated machine learning system using machine-based reasoning. Thus, the explanation engine 100 can allow people to better utilize the top level and intermediate results, to recognize when the results are in error, and can enhance a user's trust in the generated top-level results of the machine-based reasoning.

An ablation module of the explanation engine 100 can run ablation cycles to remove and/or otherwise alter a layer of the machine-based reasoning process and then go back through the reasoning tree/layers that the reasoning engine created in order to determine the effect of that layer on the final/top level result. The ablation module can include compare and loss functions to assist in determinations.

A crawl back module of the explanation engine 100 is configured to go back through each step of the machine-based reasoning process (e.g., decision process) and collect the data of each layer in the reasoning process.

The crawl back module cooperates with the messaging module to collect the top-level result as well as one or more intermediate output results from intermediate layers of the machine-based reasoning process to put into a communication. The messaging module can also include compare and loss functions.

The modules of the explanation engine 100 cooperate to provide the ability for a system with a machine-based reasoning process using machine learning to support people more effectively in their jobs, allowing users/people to have more confidence in the outputs of such systems, and help create a broader adoption of automated reasoning.

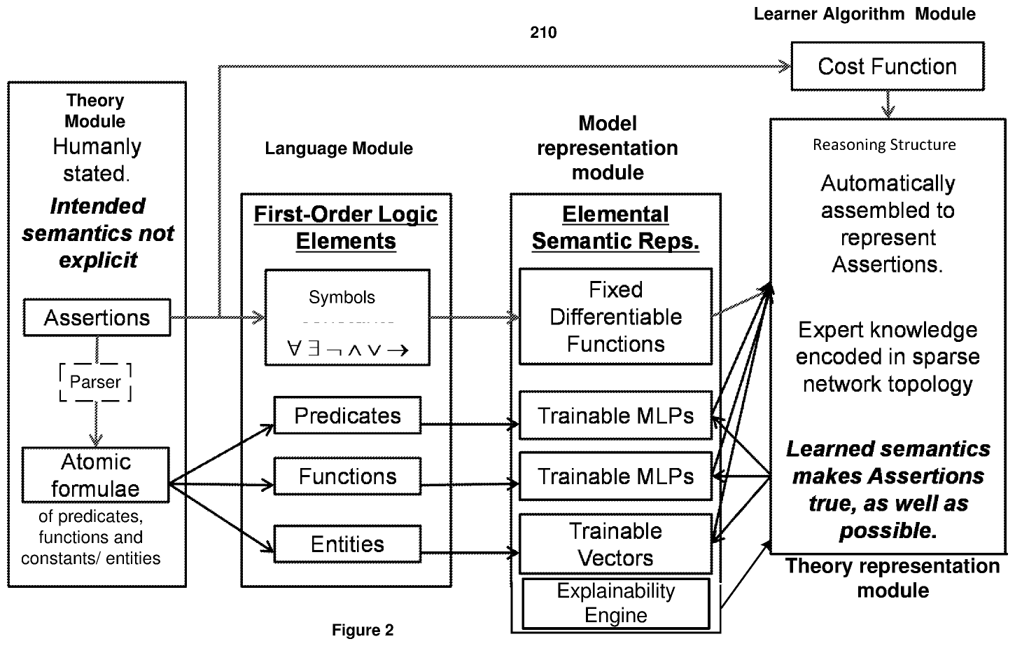

FIG. 2 illustrates an embodiment of an example reasoning engine configured to break down its machine-based reasoning process (e.g., decision process) into divisible layers/intermediate steps that provide intermediary output results to other layers and a top-level result.

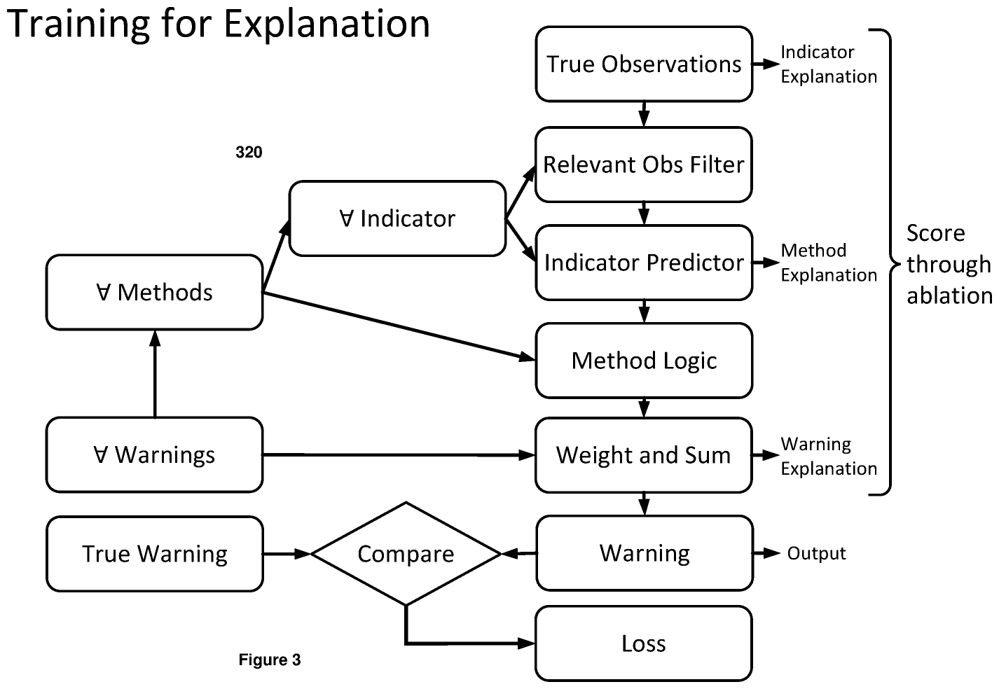

The reasoning engine 210, such as the Deep Adaptive Semantic Logic (DASL) system by SRI International, creates each layer and flow of the layers of the machine-based reasoning process. The reasoning engine 210 builds a hierarchical reasoning tree/process of individual neural networks, logical rules, linear layers, etc. into a hierarchical structure such as a tree structure or other hierarchical structure (See, e.g., FIG. 3).

The example reasoning engine 210 can have a theory module, a language module, a model representation module, and other example modules. Each module does its own function in putting the problem from the user translated into layers in a hierarchical architecture of a machine-based reasoning process implemented in logic and software.

A translator module can take input in human terminology of what the user wants and any rules supplied by the user via the theory module; and then, that is translated via the additional modules of the reasoning engine 210 into the machine-based reasoning process implemented via logical rules, linear layers, neural networks, and any combination of these.

The theory module of the reasoning engine 210 is configured to provide the translation of a user's words into the logical rules that the machine learning can understand and use, to create linear layers, neural networks, and logical rules combining multiple complex outputs, built on, for example, the DASL framework using DASL to implement the large theories and to evaluate the smaller sub-theories used in the reasoning process. The reasoning engine 210 creates layers of the machine-based reasoning process as the neural networks, logical rules, linear layers, etc. to perform the specific reasoning function in that layer. For example, see FIG. 3 the different functional layers in the reasoning process layers of method logic, relevant Obs filter, ∀ Indicator, warning, etc.

In the language model and model representation modules, the reasoning engine 210 complies a user's written domain specific language corresponding to a modified version of first order logic into neural networks, etc., and then pieces/implements flow connections together, and then creates an overall hierarchical architecture of the machine-based reasoning process that the leaner algorithm module can train. Each layer can be trained individually to perform its function and generate its reasoned intermediate output result.

When the code for the current problem is run, then each layer/functional block generates its reasoned intermediate output, which is factored into the top-level result. The intermediate output results from all of the layers of reasoning goes into the final layer of reasoning, such as the warning layer in FIG. 3, to generate the top-level result.

The reasoning engine 210 can use a library of neural networks to choose an appropriate neural network for the function of that layer in order to compile the neural network, such as a linear layer. The reasoning engine 210 can use simple logic to build logical rules from the user and/or a domain specific database of known terms and known rules in that domain. Each layer of the machine-based reasoning process computes an intermediate output result until a final layer generates the top-level result.

The reasoning engine 210 builds the architecture of the machine-reasoning process to solve a problem and can also build the modules of the explanation engine at the same time as tools to extract and format the explanations from the machine-reasoning process. Thus, the explanation engine can cooperate with a reasoning engine 210 that is configured to break down its machine-based reasoning process into divisible layers that provide intermediary output results to other layers in order to ultimately determine the top-level result from the machine-based reasoning process; as opposed to another type of reasoning engine 210 that is solely configured to create one omnibus neural network that is compiled as a black box that merely outputs its final decision. The explanation engine can cooperate with the reasoning engine 210 to allow a user to query what are the intermediary output results for each layer/step in the machine-based reasoning process as well as what would happen when the intermediary output results were altered.

The ablation module of the explanation engine runs ablation cycles removing a layer/block out of the reasoning process and compares the ablation result with the true result to determine that layer's effect on the true top-level result from the machine-based reasoning process.

The crawl back module can also extract outputs and explanations from the reasoning engine 210 via initially querying the reasoning engine 210. The terminology module can format the explanations into terminology understandable by the user. The explanation engine then explains results of each layer in terms of contribution of each lower layer based on ablation. Thus, the network for the machine-based reasoning process explains larger logic theory outputs in terms of the outputs of smaller logic theories that are domain specific and in terms relevant to the problem at hand. A primary payoff of the explanation engine is the ability to explain results produced by a reasoning engine 210 with a machine-based reasoning process in terminology users would understand.

Again, the hierarchical architecture of the reasoning process using machine-based learning can use layers in the reasoning created with low level neural networks, logical rules, linear layers; etc. In an embodiment, a linear layer can be used to learn an average rate (or a mean, etc.) of a correlation between the output and the input; for instance, if x and y are positively correlated=>w will be positive, which generate an output result. In an embodiment, a neural network can be a set of algorithms intended to recognize patterns and interpret data through clustering or labeling to recognize underlying relationships in a set of data and generate an output result. Generally, the construction of a neural network will be used to solve a more complex sub-theory/layer with more multiple variables or other complexity issues. The set of logical rules can be translated from a user's supplied rules and/or domain specific known rules into the structure of the created machine-based reasoning process. Generally, logical rules can be used to solve a simpler and/or straight forward sub-theory/layer. Logical rules can also generally be used for other simple decisions in the reasoning process such as which layer of reasoning flows into another layer of reasoning.

Note, machine learning may use many example types of neural networks such as a Feedforward Neural Network, a Radial basis function Neural Network, a Kohonen Self Organizing Neural Network, a Recurrent Neural Network, a Convolutional Neural Network, etc., and any combinations of these. Other types of relevant networks are “Transformers, Generative Adversarial Network, Restricted Boltzman Machines, etc . . . .

In an embodiment, additional details on how an example reasoning engine 210 translates a user's description of a problem into layers making up the hierarchical architecture of the machine-based reasoning process can be found US patent publication No.: US 2020/0193286, published Jun. 18, 2020, Titled “DEEP ADAPTIVE SEMANTIC LOGIC NETWORK, application. Ser. No. 16/611,177, filed Nov. 5, 2019, which is incorporated herein by reference.

FIG. 3 illustrates an embodiment of a block diagram of example layers in a hierarchical architecture of a machine-based reasoning process created by a reasoning engine with terminology used in at least one of i) a problem being solved and ii) a domain pertinent to the problem.

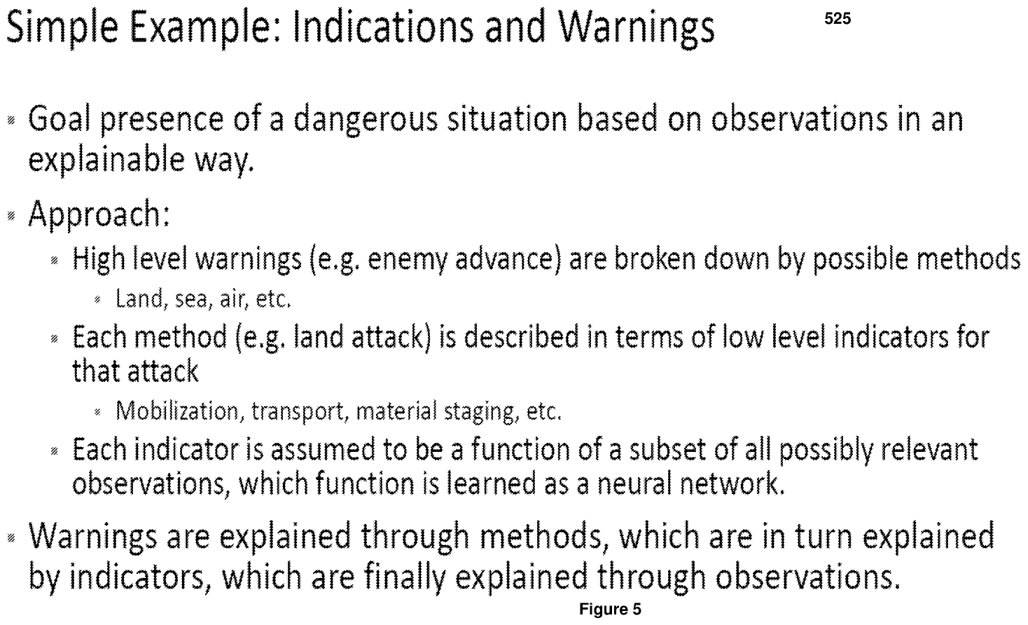

In this example, the layers in the hierarchical architecture of a machine-based reasoning process 320 are a relevant Obs filter layer, an indicator predictor layer, a method logic layer, a weight and sum layer, a warning layer, a V methods layer, a v indicator layer, a V warnings layer, a true warning layer, and a loss layer. The warnings layer in this example generates the final top-level result of a Score. The example layers are derived from the user's written description (See, e.g., FIG. 5) and/or other terminology in the domain of the problem.

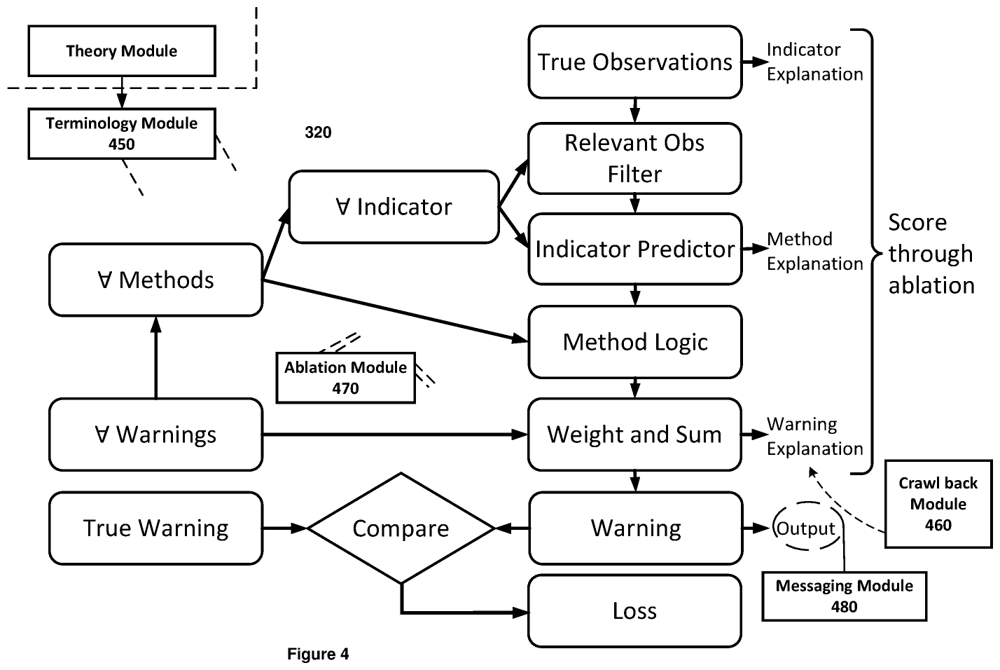

FIG. 4 illustrates a block diagram of an embodiment of the example machine-based reasoning process 320 and the modules of the explanation engine set to interact with and crawl through a decomposition of the machine-based reasoning process 320, collect the information, and then report intermediate output results from each layer of the reasoning process to explain the top-level result in terms of the intermediate output results.

Referring to FIGS. 3 and 4, again, the terminology module 450 is configured to crawl through the generated hierarchical architecture of the machine-based reasoning process 320 (e.g., reasoning tree), to be created by the reasoning engine, and then associate i) the terminology specific to the problem and/or terminology specific to a relevant subject matter domain with ii) each of the layers making up the hierarchical architecture of the machine-based reasoning process 320.

Thus, the true observations layer is created by the reasoning engine to, for example, collect all of the true observations needed to be inputted to solve the problem of, for example from FIG. 5, determining a presence of a dangerous situation based on observations. The terminology module 450 can assign the label of the layer created by the reasoning engine to be true observations, which is derived from the description of the problem submitted by the user. The output results of the true observations layer can be fed as input to the layer of reasoning labeled relevant Obs (observations) filter layer. The relevant Obs (observation) filter layer is assigned its name based on the problem and subject domain. The relevant Obs filter layer could be constructed as a simple linear layer to take in the inputs from the true observations layer to filter relevant observations for the problem of the determining a presence of a dangerous situation based on observations from observations not found useful. Likewise, the indicator predictor layer could be constructed as a neural network to take in the inputs from the relevant Obs filter layer and the v indicator layer. Often, the flow of layers of reasoning between different blocks of layers can be implemented through logical rules that can come from i) directly supplied by the user in their description of the problem statement, ii) implicit to that subject domain extracted from a specific subject domain database, or iii) even based on past or expert input that have generally proved to be accurate/useful. The remainder of the layers of reasoning are similar with the reasoning engine creating an implementation for that layer/step of reasoning and the terminology module 450 mapping a label to that layer, which is derived from the problem description from the user and/or extracted from the database. In general in this example, the output result from a previously layer flows into subsequent lower layers. Eventually in this example, the warning layer/step takes input from the above weight and sum layer, which factored in inputs and intermediate output results from the other layers of reasoning; and then, outputs a reasoned top-level result of Output.

Next, the explanation engine and its modules can do their functions to help a user understand how the example hierarchical architecture of the machine-based reasoning process 320 for the problem of determining a presence of a dangerous situation based on observations arrived at its Output. The explanation engine can explain the results of each layer in terms of contribution of each of the layers based on ablation as well as crawling back to collect the contributions and intermediate output results.

The reasoning engine builds this hierarchical reasoning tree/process of individual neural networks, logical rules, and linear layers into a hierarchical structure such as a tree structure, to conduct the machine-based reasoning process 320 carried out by the combination of machine learning and logical rules, and then captures an output result of each intermediate output result from the layers making up that hierarchical reasoning process as well as putting those output results into language used by a person in that field of work to create explanations of what the intermediate reasoning was and in terminology (e.g., words, symbols, etc.) that a user can easily understand.

Thus, the user can provide a written description of the problem, and can supply that to a reasoning engine, such as DASL, then the reasoning engine complies the machine-based reasoning process 320 using machine learning into neural networks, linear layers, logical rules, etc., and then the explanation engine does its thing.

The terminology module 450 can receive input of problem terms and domain specific terms from the words, symbols, etc., that the user gave the explanation engine as input and/or are drawn from a database of known rules and terms specific to that domain. The theory module of the reasoning engine can cooperate with the terminology module 450 to provide the terminology.

The crawl back module 460 cooperates with the messaging module 480. The crawl back module 460 of the explanation engine is configured to crawl through a decomposition of the machine-based reasoning process 320 to collect and then report intermediate output results from multiple layers of the reasoning process to explain the top-level result in terms of the intermediate output results.

The crawl back module 460 also cooperates with an ablation module 470 to trace back on each intermediate layer of the machine-based reasoning process 320 constructed by a reasoning engine to record factors being considered and how important that factor was into arriving at the top-level result from the machine-based reasoning process 320, which is then presented in the communication from the messaging module 480.

The explanation engine has an ablation module 470 configured to remove each intermediate layer of the machine-based reasoning process 320, one at a time, and runs the reasoning engine for a result, and then puts them back in for the next ablation cycle removing a different layer. Each time, the result from the ablation cycle removing a layer is compared to the initial final result of the system with the reasoning process using machine learning when all of the layers of the reasoning process were factored in into its decision. Based on the comparison, the messaging module 480 of the explanation engine can determine how much of an impact each individual layer, associated directly with the words/terms used in the users written description, has on determining the final result of the system with the reasoning process using machine learning when all of the layers were factored in into its decision. The ablation module 470 can be triggered and directed by a user making a question/query into the explanation engine. The ablation module 470 removes a layer from the reasoning flow by altering an input, such as a zero weight, for that layer. the explanation engine has an ablation module 470 configured to change output results from layers from the machine-based reasoning process 320 by altering an input for that layer and record a new output result from that layer of the machine-based reasoning process 320 as well as a new top-level result.

The ablation module 470 conducts one or more ablation cycles to alter an input to a layer of the machine-based reasoning process 320 created by a reasoning engine to determine an effect of that layer on the top-level result and record the effect. Thus, the ablation module 470 can change the input data to a layer, explain results of each layer in the reasoning process in terms of contribution of each lower layer based on ablation (removal/analysis) of a layer at a time (either determined analytically, or through small experiments).

The messaging module 480 is configured to then take all of the output results of the ablation cycles and data generated with them in order to generate the reported results of an impact of each layer of machine-based reasoning process 320 in the communication generated by the messaging module 480.

The messaging module 480 of the explanation engine is configured to 1) extract the intermediate output results from each layer of the machine-based reasoning process 320 created by a reasoning engine and 2) cooperate with a terminology module 450 to associate the intermediate output results from each layer with terminology taken from at least one of i) a subject domain and ii) problem specific terminology, which is presented in the generated communication.

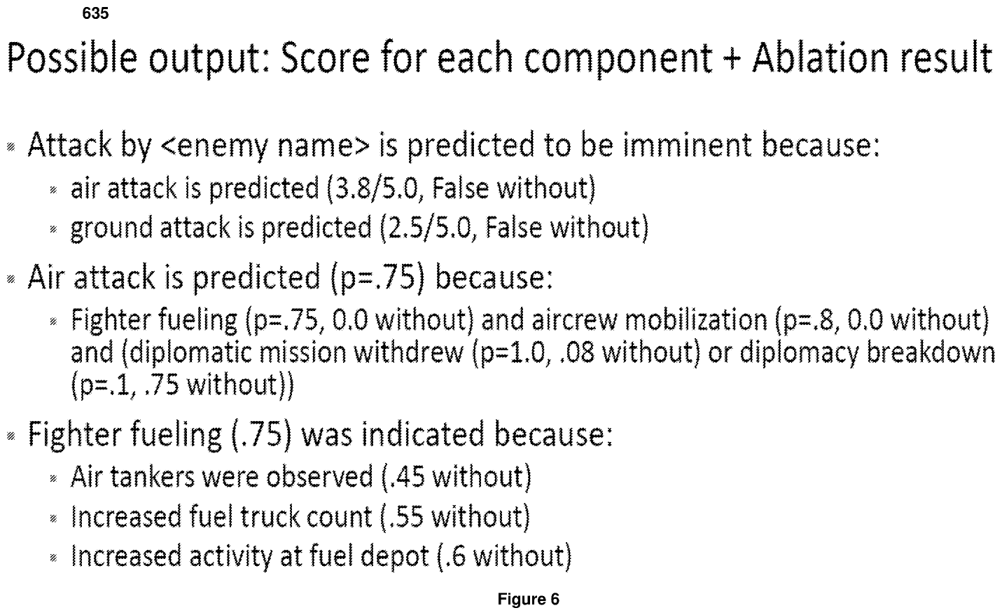

The messaging module 480 and/or ablation module 470 can use the compare and loss functions to determine the effect of altering an input and/or removing a layer of reasoning. In this example, see FIG. 6, the messaging module 480 breaks down a top-level result (e.g., Score) through ablation of the method layer, Indicator layer, warning layer, etc. in the example generated communication.

FIG. 5 illustrates a block diagram of an embodiment of an example problem specific terminology where the terminology that is assigned to each layer of the machine-based reasoning process can come directly from a user provided written description of the problem and/or is extracted from a domain specific database.

The user can submit a problem 525 (in this case, just an example problem) to the theory module of the reasoning engine.

For example:
“The goal is to determine a presence of a dangerous situation based on observations, in an explainable way.
The reasoning engine compiled a machine-based reasoning process broken down into the sub theories/layers to explain its reasoning:
   High level warnings (e.g., enemy advance) are broken down by possible methods—land, sea, air, etc.
   Each method (e.g., land attack) is described in terms of low-level indicators for that attack—mobilization, transport, material staging, etc.
   Each indicator is assumed to be a function of a subset of all possibly relevant observations, which function is learned as a neural network.
   Warnings are explained through methods, which are in turn explained by indicators, which are finally explained through observations.”

Accordingly, the reasoning engine solves this problem 525 submitted by a user by building a problem-specific high-level flow of layers of reasoning for capturing the machine-based reasoning process into the layers (e.g., neural networks, linear layers, logical rules) being used by the machine learning, associating domain specific names to the layers using the understandable terminology.

FIG. 6 illustrates a block diagram of an embodiment of an example communication generated by a messaging module cooperating with an ablation module to trace back on each intermediate layer of the machine-based reasoning process to record factors being considered and how important that factor was into arriving at the top-level result from the machine-based reasoning process.

The messaging module of the explanation engine produces a communication 635 of the results using problem specific logical connectives and linear weights that fuse the outputs of low-level neural networks, logical rules, and/or linear layers.

The example communication 635 may present intermediate results from multiple layers along with its problem and/or domain specific name, and the eventual top-level result, e.g., ‘Score,’ and the scores of the intermediate output results.

The communication 635 presents a score for the layers prior any ablation cycle and the effect of an ablation cycle; and thus, each layer's contribution to the outputted ‘Score’ from the top-level result from the warnings layer:

“1A. Attack by <enemy name> is predicted to be imminent because:
1A-1. Air attack is predicted (3.8/5.0, False without), and
1A-2. Ground attack is predicted (2.5/5.0, False without).
   1A-1i. Air attack is predicted (p=0.75) because:
Fighter fueling (p=0.75, 0.0 without) and aircrew mobilization (p=0.8, 0.0 without) and (diplomatic mission withdrew (p=1.0, 0.08 without) or diplomacy breakdown (p=0.1, 0.75 without))
   1A-1ii. Fighter fueling (0.75) was indicated because:
   Air tankers were observed (0.45 without)
   Increased fuel truck count (0.55 without)
   Increased activity at fuel depot (0.6 without).”

Note, the layers of reasoning are outputting numbers, such as score, which is the language of machine-based reasoning. However, the terminology module assigns terminology from any of the domain pertinent to the problem and the specific problem at hand, for each layer in the hierarchical architecture of the machine-based reasoning process created by the reasoning engine, which allows a human user to match explanations with terminology a human user can understand in the communication 635 generated by the messaging module. Thus, the user is able to understand the results in terms of the specific problem or domain, based on the words and format that the communication is generated.

In the above example, the ablation module has run ablation cycles to zero out aspects of an input into a given layer to run the reasoning engine and see what the new values are for intermediary results from the functional layers during that ablation cycle and/or a new top-level result/score.

The messaging module then takes all of the results of the ablation cycles and data generated with them to generate a generated communication of the impact of each functional block/layer on the final result from the reasoning engine.

The explanation engine can be used with any system with a machine-based reasoning process (e.g., using machine learning). For example, applications in military uses, autonomous vehicle uses, virtual assistant uses, etc., to explain why, for example, the virtual assistant arrived at its recommendation (e.g., top-level result).

Note, one or more portions of the explanation engine can be coded in python files.

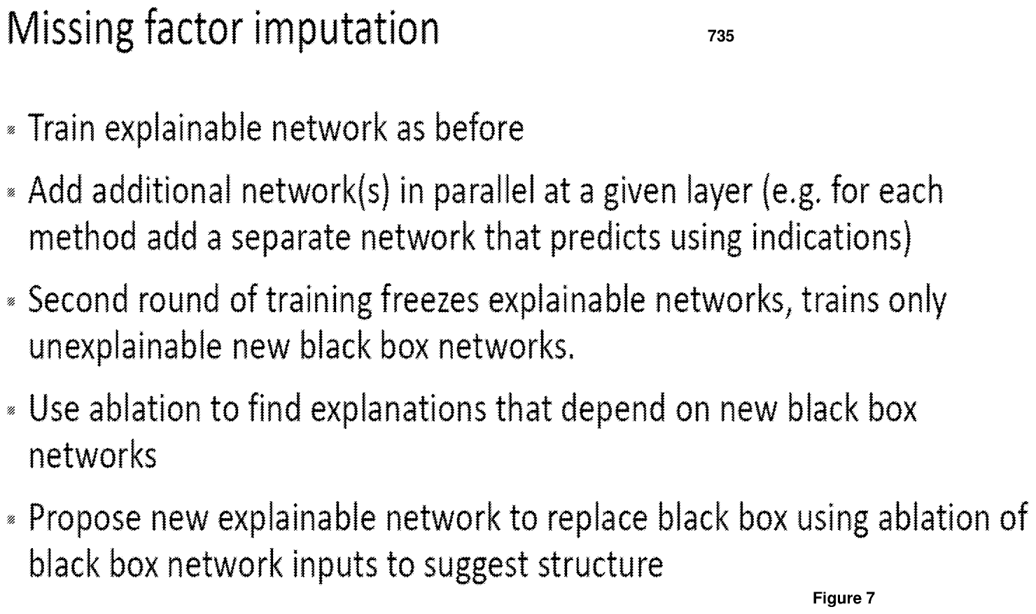

FIG. 7 illustrates a block diagram of an embodiment of another page in the communication generated by the messaging module explaining potential errors or improvements in the machine-based reasoning process.

The messaging module can review the data collected by the crawl back module and the ablation module and then use some artificial intelligence algorithms to explain potential errors or improvements in the machine-based reasoning process and put that into the communication 735. Thus, the generated results can be presented with either 1) additional pre hoc information, when no similar learning examples are available, but still suggesting ways that this learning may be performed differently, and 2) additional ad hoc information, based on past/historical learning examples, that the user may want to alter weights, other learning parameters, and learning algorithms, differently than currently implemented. This additional information can optionally be shown in the communication. For example, the messaging module could provide the following example errors and/or made suggestions in the communication 735:
Train explainable network as before but add additional network(s) in parallel at a given layer (e.g., for each method add a separate network that predicts using indications);
Add a second round of training freezes in the explainable networks, which trains only unexplainable new black box networks; and
Use ablation to find explanations that depend on new black box networks.

Note, the modules of the explanation engine cooperate to replace black box results by using at least ablation of each of the network inputs to understand effects of layers in the reasoning process as well as make suggestions on its structure.

### Network

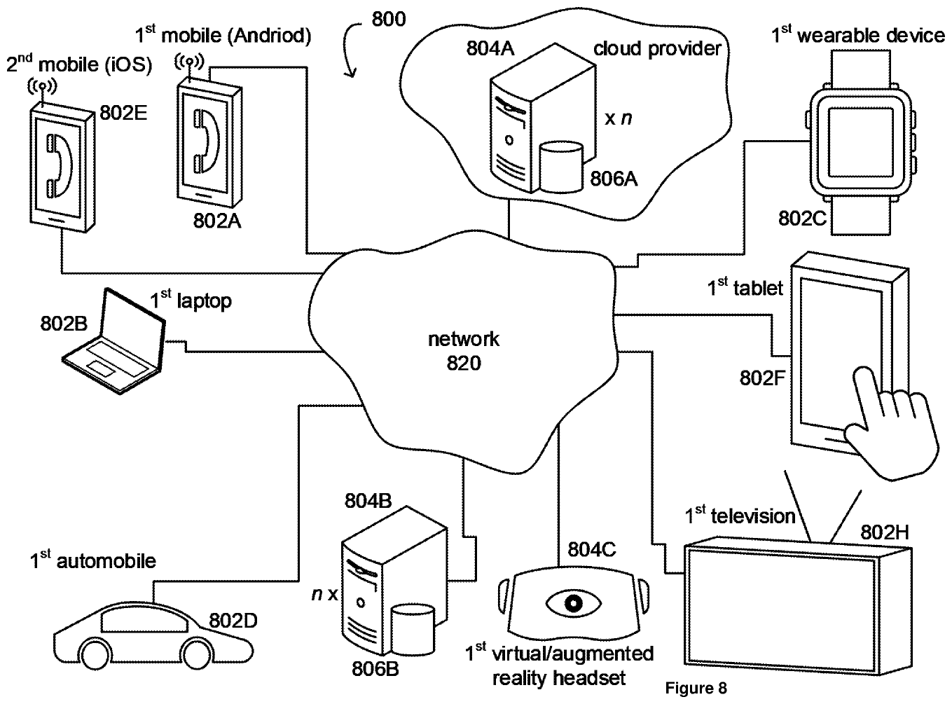

FIG. 8 illustrates a diagram of a number of electronic systems and devices communicating with each other in a network environment in accordance with an embodiment of the explanation engine cooperating with a reasoning engine. The network environment 800 has a communications network 820. The network 820 can include one or more networks selected from an optical network, a cellular network, the Internet, a Local Area Network (“LAN”), a Wide Area Network (“WAN”), a satellite network, a fiber network, a cable network, and combinations thereof. In an embodiment, the communications network 820 is the Internet. As shown, there may be many server computing systems and many client computing systems connected to each other via the communications network 820. However, it should be appreciated that, for example, a single client computing system can also be connected to a single server computing system. Thus, any combination of server computing systems and client computing systems may connect to each other via the communications network 820. As discussed, the reasoning engine can use a network like this to supply training data to create and train a neural network. The explanation engine cooperating with the reasoning engine can also reside and be implemented in this network environment, for example, in the cloud platform of server 804A and database 806A, the local server 804B and database 806B, on the device such as laptop 802D, in a smart system such as the smart automobile 802D, partially in the cloud platform server 804A and partially in the device, such as laptop 802D, where the two systems communicate and cooperate with each other, and other similar platforms.

The communications network 820 can connect one or more server computing systems selected from at least a first server computing system 804A and a second server computing system 804B to each other and to at least one or more client computing systems as well. The server computing system 804A can be, for example, the one or more server systems 220. The server computing systems 804A and 804B can each optionally include organized data structures such as databases 806A and 806B. Each of the one or more server computing systems can have one or more virtual server computing systems, and multiple virtual server computing systems can be implemented by design. Each of the one or more server computing systems can have one or more firewalls to protect data integrity.

The at least one or more client computing systems can be selected from a first mobile computing device 802A (e.g., smartphone with an Android-based operating system), a second mobile computing device 802E (e.g., smartphone with an iOS-based operating system), a first wearable electronic device 802C (e.g., a smartwatch), a first portable computer 802B (e.g., laptop computer), a third mobile computing device or second portable computer 802F (e.g., tablet with an Android- or iOS-based operating system), a smart device or system incorporated into a first smart automobile 802D, a smart device or system incorporated into a first smart bicycle 802G, a first smart television 802H, a first virtual reality or augmented reality headset 804C, and the like. The client computing system 802B can be, for example, one of the one or more client systems 210, and any one or more of the other client computing systems (e.g., 802A, 802C, 802D, 802E, 802F, 802G, 802H, and/or 804C) can include, for example, the software application or the hardware-based system in which the training of the artificial intelligence can occur and/or can be deployed into. Each of the one or more client computing systems can have one or more firewalls to protect data integrity.

It should be appreciated that the use of the terms “client computing system” and “server computing system” is intended to indicate the system that generally initiates a communication and the system that generally responds to the communication. For example, a client computing system can generally initiate a communication and a server computing system generally responds to the communication. No hierarchy is implied unless explicitly stated. Both functions can be in a single communicating system or device, in which case, the client-server and server-client relationship can be viewed as peer-to-peer. Thus, if the first portable computer 802B (e.g., the client computing system) and the server computing system 804A can both initiate and respond to communications, their communications can be viewed as peer-to-peer. Additionally, the server computing systems 804A and 804B include circuitry and software enabling communication with each other across the network 820. Server 804B may send, for example, simulator data to server 804A.

Any one or more of the server computing systems can be a cloud provider. A cloud provider can install and operate application software in a cloud (e.g., the network 820 such as the Internet) and cloud users can access the application software from one or more of the client computing systems. Generally, cloud users that have a cloud-based site in the cloud cannot solely manage a cloud infrastructure or platform where the application software runs. Thus, the server computing systems and organized data structures thereof can be shared resources, where each cloud user is given a certain amount of dedicated use of the shared resources. Each cloud user's cloud-based site can be given a virtual amount of dedicated space and bandwidth in the cloud. Cloud applications can be different from other applications in their scalability, which can be achieved by cloning tasks onto multiple virtual machines at run-time to meet changing work demand. Load balancers distribute the work over the set of virtual machines. This process is transparent to the cloud user, who sees only a single access point.

Cloud-based remote access can be coded to utilize a protocol, such as Hypertext Transfer Protocol (“HTTP”), to engage in a request and response cycle with an application on a client computing system such as a web-browser application resident on the client computing system. The cloud-based remote access can be accessed by a smartphone, a desktop computer, a tablet, or any other client computing systems, anytime and/or anywhere. The cloud-based remote access is coded to engage in 1) the request and response cycle from all web browser-based applications, 3) the request and response cycle from a dedicated on-line server, 4) the request and response cycle directly between a native application resident on a client device and the cloud-based remote access to another client computing system, and 5) combinations of these.

In an embodiment, the server computing system 804A can include a server engine, a web page management component or direct application component, a content management component, and a database management component. The server engine can perform basic processing and operating-system level tasks. The web page management component can handle creation and display or routing of web pages or screens associated with receiving and providing digital content and digital advertisements, through a browser. Likewise, the direct application component may work with a client app resident on a user's device. Users (e.g., cloud users) can access one or more of the server computing systems by means of a Uniform Resource Locator (“URL”) associated therewith. The content management component can handle most of the functions in the embodiments described herein. The database management component can include storage and retrieval tasks with respect to the database, queries to the database, and storage of data.

In an embodiment, a server computing system can be configured to display information in a window, a web page, or the like. An application including any program modules, applications, services, processes, and other similar software executable when executed on, for example, the server computing system 804A, can cause the server computing system 804A to display windows and user interface screens in a portion of a display screen space.

Each application has a code scripted to perform the functions that the software component is coded to carry out such as presenting fields to take details of desired information. Algorithms, routines, and engines within, for example, the server computing system 804A can take the information from the presenting fields and put that information into an appropriate storage medium such as a database (e.g., database 806A). A comparison wizard can be scripted to refer to a database and make use of such data. The applications may be hosted on, for example, the server computing system 804A and served to the specific application or browser of, for example, the client computing system 802B. The applications then serve windows or pages that allow entry of details.

### Computing Systems

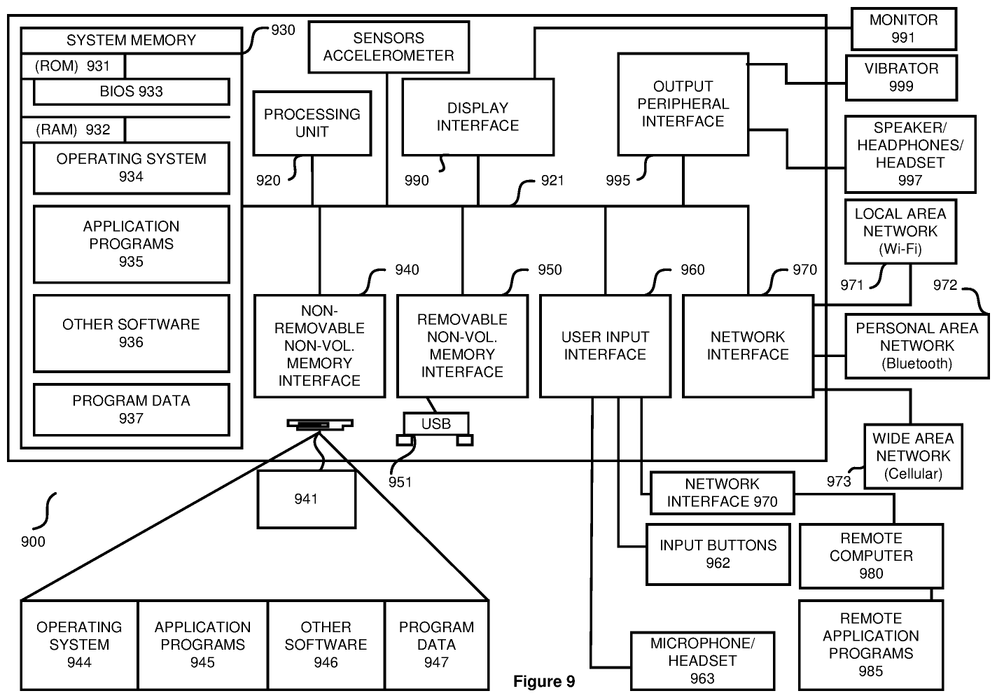

FIG. 9 illustrates a diagram of an embodiment of one or more computing devices that can be a part of the systems associated with the explanation engine cooperating with the reasoning engine and its associated models discussed herein. The computing device 900 may include one or more processors or processing units 920 to execute instructions, one or more memories 930-932 to store information, one or more data input components 960-963 to receive data input from a user of the computing device 900, one or more modules that include the management module, a network interface communication circuit 970 to establish a communication link to communicate with other computing devices external to the computing device, one or more sensors where an output from the sensors is used for sensing a specific triggering condition and then correspondingly generating one or more preprogrammed actions, a display screen 991 to display at least some of the information stored in the one or more memories 930-932 and other components. Note, portions of this system that are implemented in software 944, 945, 946 may be stored in the one or more memories 930-932 and are executed by the one or more processors 920.

The system memory 930 includes computer storage media in the form of volatile and/or nonvolatile memory such as read-only memory (ROM) 931 and random access memory (RAM) 932. These computing machine-readable media can be any available media that can be accessed by computing system 900. By way of example, and not limitation, computing machine-readable media use includes storage of information, such as computer-readable instructions, data structures, other executable software, or other data. Computer-storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible medium which can be used to store the desired information and which can be accessed by the computing device 900. Transitory media such as wireless channels are not included in the machine-readable media. Communication media typically embody computer readable instructions, data structures, other executable software, or other transport mechanism and includes any information delivery media.

The system further includes a basic input/output system 933 (BIOS) containing the basic routines that help to transfer information between elements within the computing system 900, such as during start-up, is typically stored in ROM 931. RAM 932 typically contains data and/or software that are immediately accessible to and/or presently being operated on by the processing unit 920. By way of example, and not limitation, the RAM 932 can include a portion of the operating system 934, application programs 935, other executable software 936, and program data 937.

The computing system 900 can also include other removable/non-removable volatile/nonvolatile computer storage media. By way of example only, the system has a solid-state memory 941. The solid-state memory 941 is typically connected to the system bus 921 through a non-removable memory interface such as interface 940, and USB drive 951 is typically connected to the system bus 921 by a removable memory interface, such as interface 950.

A user may enter commands and information into the computing system 900 through input devices such as a keyboard, touchscreen, or software or hardware input buttons 962, a microphone 963, a pointing device and/or scrolling input component, such as a mouse, trackball or touch pad. These and other input devices are often connected to the processing unit 920 through a user input interface 960 that is coupled to the system bus 921, but can be connected by other interface and bus structures, such as a parallel port, game port, or a universal serial bus (USB). A display monitor 991 or other type of display screen device is also connected to the system bus 921 via an interface, such as a display interface 990. In addition to the monitor 991, computing devices may also include other peripheral output devices such as speakers 997, a vibrator 999, and other output devices, which may be connected through an output peripheral interface 995.

The computing system 900 can operate in a networked environment using logical connections to one or more remote computers/client devices, such as a remote computing system 980. The remote computing system 980 can a personal computer, a mobile computing device, a server, a router, a network PC, a peer device or other common network node, and typically includes many or all of the elements described above relative to the computing system 900. The logical connections can include a personal area network (PAN) 972 (e.g., Bluetooth®), a local area network (LAN) 971 (e.g., Wi-Fi), and a wide area network (WAN) 973 (e.g., cellular network), but may also include other networks such as a personal area network (e.g., Bluetooth®). Such networking environments are commonplace in offices, enterprise-wide computer networks, intranets and the Internet. A browser application may be resonant on the computing device and stored in the memory.

When used in a LAN networking environment, the computing system 900 is connected to the LAN 971 through a network interface 970, which can be, for example, a Bluetooth® or Wi-Fi adapter. When used in a WAN networking environment (e.g., Internet), the computing system 900 typically includes some means for establishing communications over the WAN 973. With respect to mobile telecommunication technologies, for example, a radio interface, which can be internal or external, can be connected to the system bus 921 via the network interface 970, or other appropriate mechanism. In a networked environment, other software depicted relative to the computing system 900, or portions thereof, may be stored in the remote memory storage device. By way of example, and not limitation, the system has remote application programs 985 as residing on remote computing device 980. It will be appreciated that the network connections shown are examples and other means of establishing a communications link between the computing devices that may be used.

As discussed, the computing system 900 can include mobile devices with a processing unit 920, a memory (e.g., ROM 931, RAM 932, etc.), a built-in battery to power the computing device, an AC power input to charge the battery, a display screen, a built-in Wi-Fi circuitry to wirelessly communicate with a remote computing device connected to network.

It should be noted that the present design can be carried out on a computing system such as that described with respect to shown herein. However, the present design can be carried out on a server, a computing device devoted to message handling, or on a distributed system in which different portions of the present design are carried out on different parts of the distributed computing system.

In some embodiments, software used to facilitate algorithms discussed herein can be embedded onto a non-transitory machine-readable medium. A machine-readable medium includes any mechanism that stores information in a form readable by a machine (e.g., a computer). For example, a non-transitory machine-readable medium can include read-only memory (ROM); random access memory (RAM); magnetic disk storage media; optical storage media; flash memory devices; Digital Versatile Disc (DVD's), EPROMs, EEPROMs, FLASH memory, magnetic or optical cards, or any type of media suitable for storing electronic instructions.

Note, an application described herein includes but is not limited to software applications, mobile applications, and programs that are part of an operating system application. Some portions of this description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms can be written in a number of different software programming languages such as C, C++, HTTP, Java, Python, or other similar languages. Also, an algorithm can be implemented with lines of code in software, configured logic gates in software, or a combination of both. In an embodiment, the logic consists of electronic circuits that follow the rules of Boolean Logic, software that contain patterns of instructions, or any combination of both. Any portions of an algorithm implemented in software can be stored in an executable format in portion of a memory and is executed by one or more processors.

It should be borne in mind, however, that all of these and similar terms are to be associated with the appropriate physical quantities and are merely convenient labels applied to these quantities. Unless specifically stated otherwise as apparent from the above discussions, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers, or other such information storage, transmission or display devices.

Many functions performed by electronic hardware components can be duplicated by software emulation. Thus, a software program written to accomplish those same functions can emulate the functionality of the hardware components in input-output circuitry. Thus, provided herein are one or more non-transitory machine-readable medium configured to store instructions and data that when executed by one or more processors on the computing device of the foregoing system, causes the computing device to perform the operations outlined as described herein. In an embodiment, a module can be implemented in i) software—algorithms, routines, apps, etc. cooperating with electronic hardware, such as memories and CPUs/GPUs; ii) logic gates configured to receive an input, perform a desired functionality, and output the results; iii) other forms of electronic circuits; and/or iv) a combination of these.

References in the specification to “an embodiment,” “an example”, etc., indicate that the embodiment or example described may include a particular feature, structure, or characteristic, but every embodiment may not necessarily include the particular feature, structure, or characteristic. Such phrases can be not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

While the foregoing design and embodiments thereof have been provided in considerable detail, it is not the intention of the applicant(s) for the design and embodiments provided herein to be limiting. Additional adaptations and/or modifications are possible, and, in broader aspects, these adaptations and/or modifications are also encompassed. Accordingly, departures may be made from the foregoing design and embodiments without departing from the scope afforded by the following claims, which scope is only limited by the claims when appropriately construed.

What is claimed is:

1. An apparatus, comprising:
an explanation engine having a set of modules cooperating with each other configured to evaluate layers in a hierarchical architecture of a machine-based reasoning process that uses machine learning to support an explanation of how the machine-based reasoning process arrived at its reported results of both a top-level result as well as corresponding intermediate output results, and
a messaging module of the explanation engine configured to collect the top-level result as well as one or more intermediate output results from intermediate layers of the machine-based reasoning process, where multiple layers of reasoning are associated with terminology used in at least one of i) a problem to be solved and ii) a domain pertinent to the problem in order to communicate how the machine-based reasoning process came to its reported results in a communication.

2. The apparatus of claim 1, where the explanation engine has a terminology module configured to assign terminology from any of i) the domain pertinent to the problem and ii) the specific problem to be solved, for the multiple layers in the hierarchical architecture of the machine-based reasoning process supplied from a reasoning engine, where the user is able to understand the results in terms of the specific problem or domain based on the way the communication is generated.

3. The apparatus of claim 1, where the explanation engine has a terminology module of the explanation engine configured to accept input of terminology for the problem to be solved that is supplied by at least one of i) a description of the problem to be solved ii) a description of preferred approach to solve the problem from a user, and iii) a database of known terminology specific to the domain pertinent to the problem, and
where the terminology module is configured to crawl through the hierarchical architecture of the machine-based reasoning process, to be created by a reasoning engine, and then associate i) the terminology specific to the problem to be solved supplied by the user and/or terminology specific to a relevant subject matter domain with ii) the multiple layers making up the hierarchical architecture of the machine-based reasoning process.

4. The apparatus of claim 1, where the explanation engine is configured to cooperate with a first reasoning engine that is configured to break down its machine-based reasoning process into divisible layers that provide intermediary output results to other layers in order to determine the top level result from the machine-based reasoning process; as opposed to a second reasoning engine that is configured to create one omnibus neural network that is compiled as a black box that merely outputs its final decision; and
where the explanation engine is configured to cooperate with the first reasoning engine to allow a user to query what the intermediary output results are for each layer of the machine-based reasoning process as well as what would happen when the intermediary output results were altered.

5. The apparatus of claim 1, where the explanation engine has a crawl back module configured to cooperate with an ablation module to trace through the intermediate layers of the machine-based reasoning process constructed by a reasoning engine to record factors being considered and how important that factor was into arriving at the top-level result from the machine-based reasoning process.

6. The apparatus of claim 1, where the explanation engine has a crawl back module configured to cooperate with the messaging module, where the crawl back module of the explanation engine is configured to crawl through a decomposition of the machine-based reasoning process to collect and then report the intermediate output results from the multiple layers of the reasoning process to explain the top-level result in terms of the intermediate output results.

7. The apparatus of claim 1, where the explanation engine has an ablation module configured to change the intermediate output results from layers of the machine-based reasoning process by altering an input for that layer and then output a new intermediate output result from that layer of the machine-based reasoning process as well as a new top-level result.

8. The apparatus of claim 1, further comprising:
an ablation module configured to conduct one or more ablation cycles to alter an input to a layer of the machine-based reasoning process created by a reasoning engine to determine an effect of that layer on the top-level result and record the effect; and
where the messaging module is configured to take results of the ablation cycles and data generated with them in order to generate the reported results of an impact of each layer of machine-based reasoning process in the communication generated by the messaging module.

9. The apparatus of claim 1, further comprising:
where the messaging module of the explanation engine is configured to 1) extract the intermediate output results from the multiple layers of the machine-based reasoning process created by a reasoning engine and 2) cooperate with a terminology module to associate the intermediate output results from the multiple layers with the terminology taken from the at least one of i) subject domain pertinent to the problem and ii) the problem specific terminology used in the problem to be solved.

10. A non-transitory computer-readable medium including executable instructions that, when executed with one or more processors, cause an explanation engine to perform operations as follows, comprising:
causing an explanation engine having a set of modules to evaluate layers in a hierarchical architecture of a machine-based reasoning process that uses machine learning to support an explanation of how the machine-based reasoning process arrived at its reported results of both a top-level result as well as corresponding intermediate output results, and
causing a messaging module of the explanation engine to collect the top-level result as well as one or more intermediate output results from intermediate layers of the machine-based reasoning process, where each layer of reasoning is associated with terminology used in at least one of i) a problem being solved and ii) a domain pertinent to the problem in order to communicate how the machine-based reasoning process came to its reported results in a communication.

11. A method for explaining machine-based reasoning, comprising:
configuring an explanation engine having a set of modules to evaluate layers in a hierarchical architecture of a machine-based reasoning process that uses machine learning to support an explanation of how the machine-based reasoning process arrived at its reported results of both a top-level result as well as corresponding intermediate output results, and
configuring a messaging module of the explanation engine to collect the top-level result as well as one or more intermediate output results from intermediate layers of the machine-based reasoning process, where each layer of reasoning is associated with terminology used in at least one of i) a problem being solved and ii) a domain pertinent to the problem in order to communicate how the machine-based reasoning process came to its reported results in a communication.

12. The method of claim 11, further comprising:
configuring a terminology module of the explanation engine to assign terminology from any of the domain pertinent to the problem and the specific problem at hand, for each layer in the hierarchical architecture of the machine-based reasoning process supplied from a reasoning engine, which allows a user to match explanations with terminology a user can understand in the communication generated by the messaging module.

13. The method of claim 11, further comprising:
configuring a terminology module of the explanation engine to accept input of terminology for the problem to be solved that is supplied by at least one of i) a description of the problem to be solved ii) a description of preferred approach to solve the problem from a user, and iii) a database of known terminology specific to the domain pertinent to the problem, and
configuring the terminology module to crawl through the hierarchical architecture of the machine-based reasoning process, to be created by the reasoning engine, and associate the problem specific terminology and/or the domain specific terminology with each of the layers making up the hierarchical architecture of the machine-based reasoning process.

14. The method of claim 11, further comprising:
configuring the explanation engine to cooperate with a first reasoning engine that is configured to break down its machine-based reasoning process into divisible layers that provide intermediary output results to other layers in order to determine the top-level result from the machine-based reasoning process; as opposed to a second reasoning engine that is configured to create one omnibus neural network that is compiled as a black box that merely outputs its final decision; and
configuring the explanation engine to cooperate with the first reasoning engine to allow a user to query what the intermediary output results are for each layer of the machine-based reasoning process as well as what would happen when the intermediary output results were altered.

15. The method of claim 11, further comprising:
configuring a crawl back module of the explanation engine to cooperate with an ablation module to trace back on each intermediate layer of the machine-based reasoning process constructed by a reasoning engine to record factors being considered and how important that factor was into arriving at the top-level result from the machine-based reasoning process.

16. The method of claim 11, further comprising:
configuring a crawl back module of the explanation engine to cooperate with the messaging module, where the crawl back module of the explanation engine is configured to crawl through a decomposition of the machine-based reasoning process to collect and then report intermediate output results from each layer of the reasoning process to explain the final top-level result in terms of the intermediate output results.

17. The method of claim 11, further comprising:
configuring an ablation module of the explanation engine to remove each intermediate layer of the machine-based reasoning process, one at a time, and evaluate an impact on the top-level result from the machine-based reasoning process.

18. The method of claim 11, further comprising:
configuring an ablation module of the explanation engine to change output results from layers of the machine-based reasoning process by altering an input for that layer and output a new output result from that layer of the machine-based reasoning process as well as a new top-level result.

19. The method of claim 11, further comprising:
configuring an ablation module to conduct one or more ablation cycles to alter an input to a layer of the machine-based reasoning process created by a reasoning engine to determine an effect of that layer on the top-level result and record the effect; and
configuring the messaging module to take all results of the ablation cycles and data generated with them in order to generate the reported results of an impact of each layer of machine-based reasoning process in the communication generated by the messaging module.

20. The method of claim 11, further comprising:
configuring the messaging module of the explanation engine to 1) extract the intermediate output results from each layer of the machine-based reasoning process created by a reasoning engine and 2) cooperate with a terminology module to associate the intermediate output results from each layer with terminology taken from at least one of i) the problem being solved and ii) the domain pertinent to the problem, where the terminology assigned to each layer of the machine-based reasoning process comes directly from a user provided written description of the problem and/or is extracted from a domain specific database.
